(19) United States
(12) Patent Application Publication
(10) Pub. No.: US 2024/0423162 A1
(43) Pub. Date: Dec. 26, 2024

(54) HANDHELD WASH TOOL FOR CLEANING ANIMALS AND METHODS

(71) Applicant: Spectrum Brands, Inc., Middleton, WI (US)

(72) Inventors: Gregory van Eyk, Middleton, WI (US); Jewel Cary, Middleton, WI (US); Christopher Robert Stoll, Middleton, WI (US); Lindsay Sumners, Middleton, WI (US); William D. Himes, Middleton, WI (US)

(73) Assignee: Spectrum Brands, Inc., Middleton, WI (US)

(21) Appl. No.: 18/684,548

(22) PCT Filed: Aug. 16, 2022
(86) PCT No.: PCT/US2022/040498

§ 371 Date: Feb. 16, 2024

Related U.S. Application Data
(60) Provisional application No. 63/234,441, filed on Aug. 18, 2021.

(51) Int. Cl. A01K 13/00

(52) U.S. Cl. CPC A01K 13/002

(57) ABSTRACT

A handheld wash tool for bathing an animal includes a housing adapted to receive a water source to permit water to flow from the source into an interior volume of the housing. The tool includes an animal engaging section secured to the housing and in communication with the interior volume of the housing. The animal engaging section has bristles. A cartridge is removably held by the housing. The cartridge holds one or more solutions for applying to the animal. The cartridge is held within the housing such that the one or more solutions is in communication with the animal engaging section.

### CROSS-REFERENCE TO RELATED APPLICATIONS

This application is being filed on Aug. 16, 2022, as a PCT International application and claims priority to and the benefit of U.S. Provisional Patent Application No. 63/234,441 filed Aug. 18, 2021, the disclosure of which is incorporated by reference herein in its entirety. To the extent appropriate a claim for priority is made to the above referenced application.

### TECHNICAL FIELD

This disclosure relates grooming tools for animals. In particular, this disclosure relates to a handheld wash tool for cleaning (bathing) animals, such as pets like dogs and cats.

### BACKGROUND

Many households include animals as pets. Many pets, especially dogs, need to be bathed. Bathing the animal can be difficult since many animals find the bathing process unpleasant. If there is only one person giving the bath to the animal, they often need one hand to control the animal, allowing only one free hand for controlling water, soap, and other solutions.

There is a need for making bathing animals more convenient and easier than in the past.

### SUMMARY

A handheld wash tool is provided that improves the prior art.

In one aspect, a handheld wash tool for bathing an animal is provided. The tool comprises a housing with an interior volume; the housing having a receiver adapted to receive a water source to permit water to flow from the source into the interior volume; an animal engaging section secured to the housing and in communication with the interior volume of the housing; the animal engaging section having bristles; and a cartridge removably held by the housing; the cartridge holding one or more solutions for applying to the animal; the cartridge being held within the housing such that the one or more solutions is in communication with the animal engaging section.

In example embodiments, the cartridge is constructed and arranged to hold at least two solutions in separate compartments.

In one or more embodiments, the housing includes first and second opposite ends, a top, and a bottom; the animal engaging section being along the bottom of the housing; a first axis generally orthogonal to a plane containing the animal engaging section and passing through the housing top and bottom; and a second axis passing through the first end and second end.

In an example implementation, the housing can have a first ring with a first ring central axis; the first ring central axis being contained in a plane orthogonal to the first axis; the first open ring being sized to receive the cartridge.

In examples, the housing has a second open ring with a second ring central axis; the second ring central axis being contained in a plane orthogonal to the first axis; the second open ring being sized to receive a palm of a hand, such that fingers may extend over a side of the housing while a thumb may rest on the first end of the housing.

The first end of the housing may include one or more control buttons constructed and arranged to engage the cartridge to control solution dispensed from the cartridge.

In some embodiments, the second end of the housing defines the receiver.

In one or more embodiments, the animal engaging section includes apertures having at least two selected flow patterns.

The tool can further include an adapter to selectively connect the housing to one of a shower head or a hose.

In many examples, the housing includes an ejection mechanism to selectively eject the cartridge from the housing.

In another aspect, a method of bathing an animal is provided. The method includes connecting a housing to a water source to permit water to flow from the source into an interior volume of the housing; placing bristles of an animal engaging section secured to the housing and in communication with the interior volume of the housing against the animal; and dispensing solutions from a cartridge removably held by the housing; the cartridge being held within the housing such that the solutions are in communication with the animal engaging section.

In some methods, the step of dispensing solutions includes using the cartridge to hold at least two solutions in separate compartments.

In some methods, the step of dispensing solutions includes engaging one or more control buttons on the housing to control solution dispensed from the cartridge.

Some methods further include using an ejection mechanism to selectively eject the cartridge from the housing.

In one or more example methods, the steps of placing bristles and dispensing solutions are done with a single hand holding the housing.

Some methods can include a step of grasping the housing through an open ring with a human hand so that the hand is in the ring between a handle and a remaining part of the housing.

It is noted that not all the specific features described herein need to be incorporated in an arrangement for the arrangement to have some selected advantage according to the present disclosure.

### BRIEF DESCRIPTION OF THE DRAWINGS

FIG. 1 is perspective view of an embodiment of a handheld wash tool, constructed in accordance with principles of this disclosure;

FIG. 2 is a top view showing the tool of FIG. 1 with a hand controlling the tool;

FIG. 3 is a side elevational view of the tool of FIG. 1;

FIG. 4 is an exploded perspective view of the tool of FIG. 1, with a cleaning cartridge exploded from the housing;

FIG. 5 is a perspective view of a step of refilling the cartridge of FIG. 4;

FIG. 6 is a perspective view showing the tool of FIG. 1 connected to a showerhead;

FIG. 7 is an enlarged view of the connection of FIG. 6;

FIG. 8 is a perspective view showing the tool of FIG. 1 connected to a hose spigot;

FIG. 9 is an enlarged view of the connection of FIG. 8; and

FIG. 10 a pair of bottom perspective views of the tool of FIG. 1 showing two different spray patterns.

The present technology may be more completely understood and appreciated in consideration of the following detailed description of various embodiments in connection with the accompanying drawings.

The figures are rendered primarily for clarity and, as a result, are not necessarily drawn to scale. Moreover, various structure/components, including but not limited to fasteners, and the like, may be shown diagrammatically or removed from some or all of the views to better illustrate aspects of the depicted embodiments, or where inclusion of such structure/components is not necessary to an understanding of the various exemplary embodiments described herein. The lack of illustration/description of such structure/components in a particular figure is, however, not to be interpreted as limiting the scope of the various embodiments in any way.

### DETAILED DESCRIPTION

A handheld wash tool is shown in general at 20. The tool 20 allows users to bathe their pet with one hand, while restraining with the other, indoor or outdoor.

The tool 20 includes a housing 22 and an animal engaging section 24 secured to the housing 22. In the embodiment shown, the housing 22 includes first and second opposite ends 34, 36; a top 38; and a bottom 40. A first axis 42 is generally orthogonal to a plane containing the animal engaging section 24 and passes through the housing top 38 and bottom 40. A second axis 44 passes through the first end 34 and second end 36.

The tool 20 further includes a cartridge 50 removably held by the housing 22. The cartridge 50 holds one or more solutions for applying to the animal. The cartridge 50 is held within the housing 22 such that the one or more solutions is in communication with the animal engaging section 24. The one or more solutions can include shampoo, conditioner, or various other types of bathing solutions.

The cartridge 50 is sized and shaped to be removably mountable within the housing 50. The cartridge 50 can have at least two distinct chambers, for holding two different cleaning solutions, such as shampoo in one, and conditioner in the other.

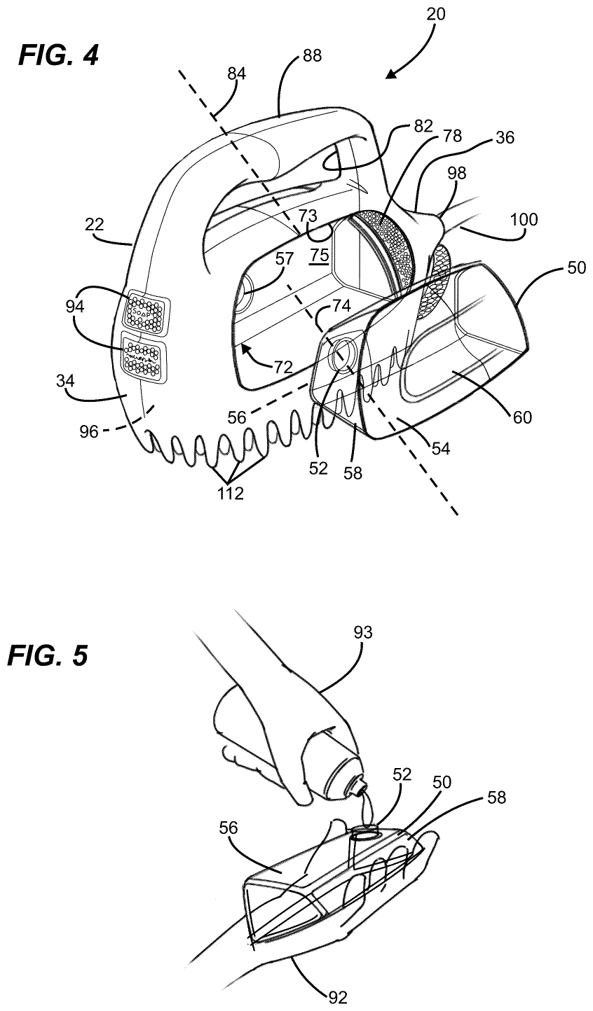

The cartridge 50 includes an opening that is closeable with a gasket seal 52 (FIG. 4). The gasket seal 52 can be removed and allow access to the interior of the cartridge 50 to allow for refilling, as shown in FIG. 5. FIG. 5 shown a person holding the cartridge 50 in one hand 92, while filling the cartridge 50 with a bottled solution 91 being held by the other hand 93.

Referring to FIGS. 4 and 5, the cartridge 50 has a front face 54; an opposite rear face 56; and a surrounding sidewall 58 extending between the front face 54 and rear face 56. The rear face 56 is shown as holding the gasket seal 52, and is positioned to be in fluid communication with an inlet port 57 in the housing 22. The front face 54 can have a concave inset 60 to act as touchpoints and help secure them.

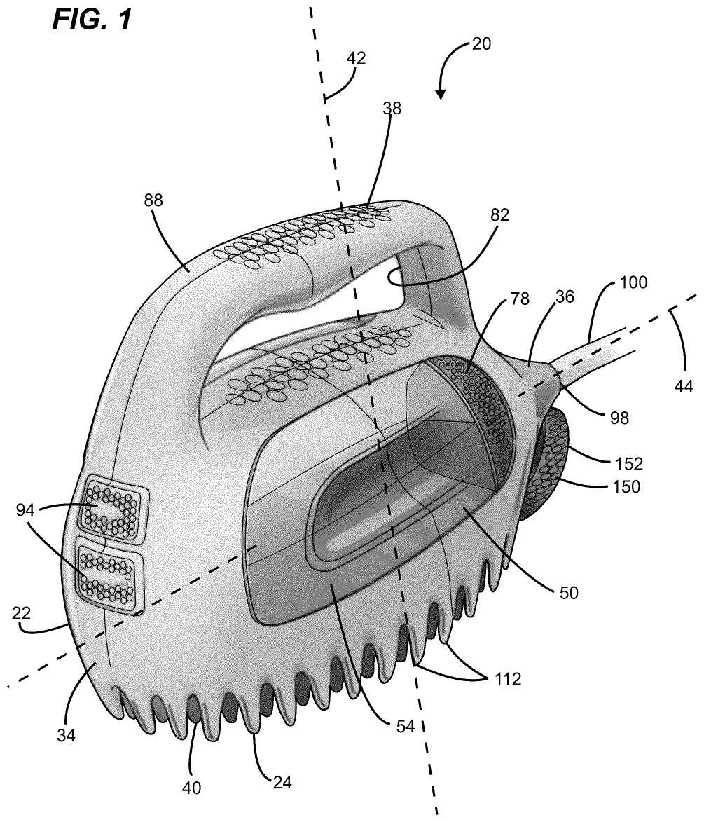

The housing 22 has a first ring 72 with a first ring central axis 74. The first ring central axis 74 is contained in a plane orthogonal to the first axis 42. The first ring 72 is sized to receive the cartridge 50. As can be seen in FIG. 1, the inner perimeter opening 73 of the first open ring 72 has the same general shape as the outer perimeter profile shape of the cartridge 50. The first ring 72 has a closed end 75, defining the inlet port 57.

The housing 22 includes an ejector mechanism 78. The ejector mechanism 78 is located adjacent to the first open ring 72. The ejector mechanism 78 engages/interacts with the cartridge 50 to help eject the cartridge 50 from the first open ring 72 of the housing 22, when it is desired to remove the cartridge 50 for cleaning or refilling. The ejector mechanism 78 can be a spring-loaded push button, for example.

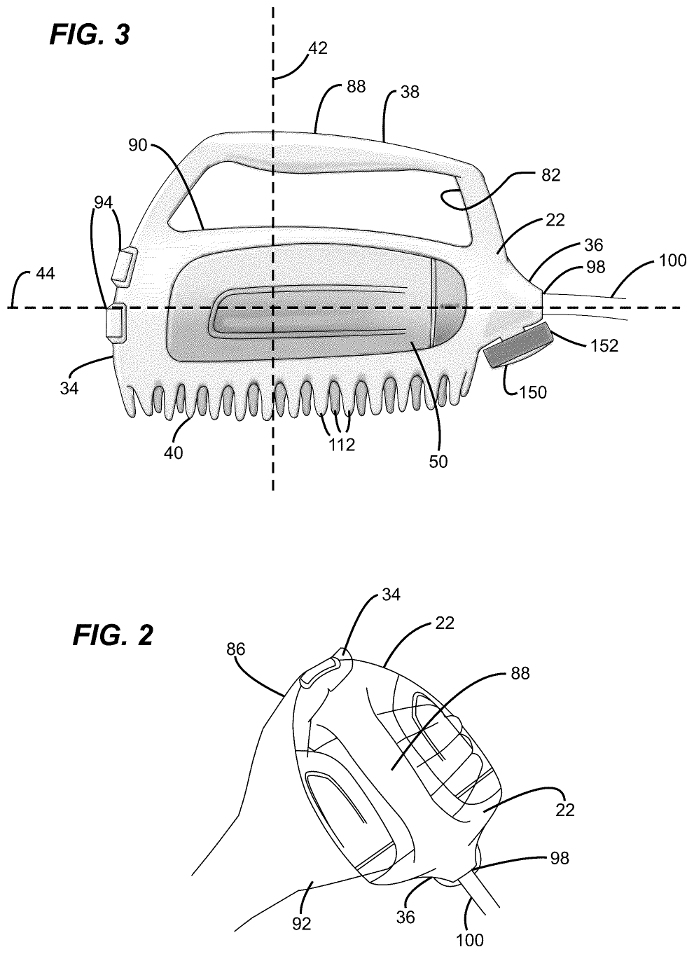

The housing 22 has a second open ring 82 with a second ring central axis 84. The second ring central axis 84 is contained in a plane orthogonal to the first axis 42. The second open ring 82 is sized to receive a palm of hand 92, such that fingers may extend over a side of the housing 22 while a thumb 86 may rest on the first end 34 of the housing 22. See FIG. 2.

The second open ring 82 is defined by a handle 88 extending over and facing a remaining part 90 of the housing 22. In use, as shown in FIG. 2, the user's hand 92 can be contained in the second open ring 82 between and against the handle 88 and the remaining part 90 of the housing 22.

In accordance with principles of this disclosure, the housing 22 includes one or more control buttons 94 constructed and arranged to engage the cartridge 50 to control solution dispensed from the cartridge 50. As illustrated in FIG. 1, the first end 34 of the housing 22 includes the control buttons 94. As shown in FIG. 2, the buttons 94 are positioned such that the user's thumb 86 can manipulate the buttons 94, while holding the tool 20. The control buttons 94 can include controls for: soak, soap, rinse, and condition. Many variations are possible.

The housing 22 has an interior volume 96 and a fluid inlet opening/receiver 98 adapted to receive a water source to permit water to flow from the source into the interior volume 96. In the embodiment shown, the second end 36 of the housing 22 defines the receiver 98. A hose 100 can be removably attached to the receiver 98 to convey liquid (e.g., water) into the interior volume 96 of the housing 22.

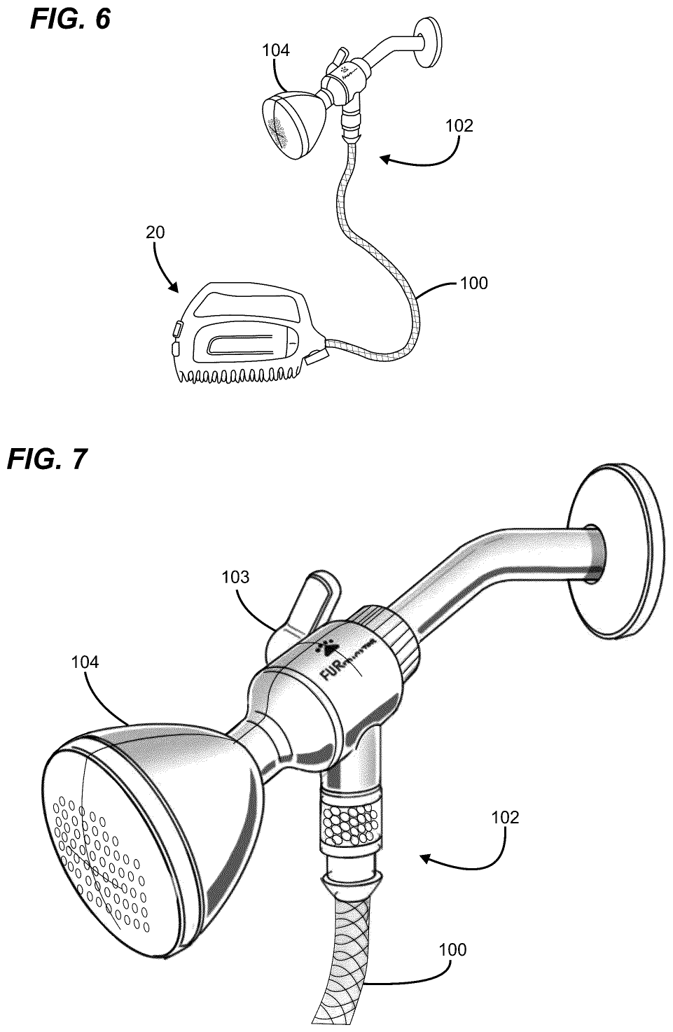

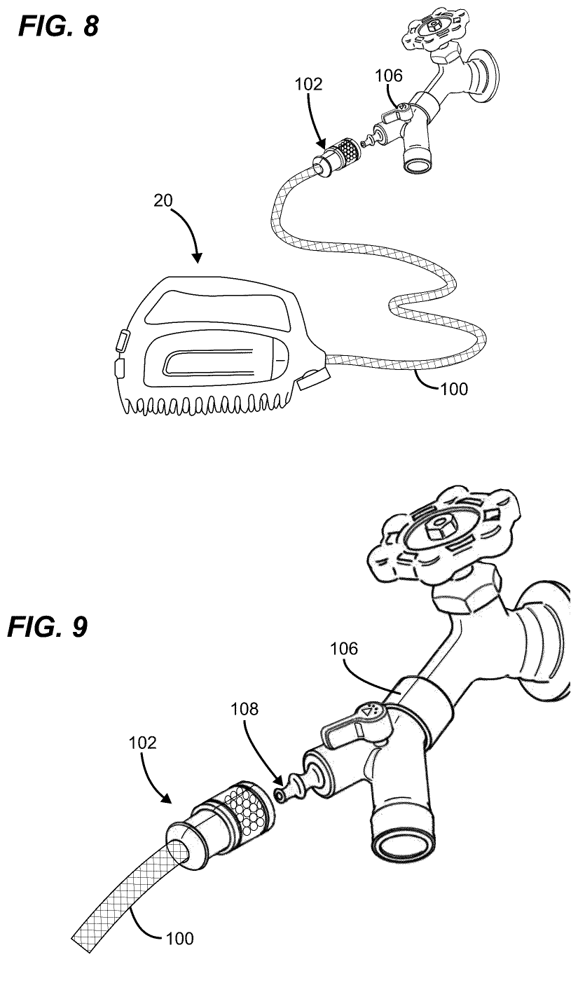

The tool 20 can further include an adapter assembly 102 (FIGS. 6-9). The adapter assembly 102 allows for selective connection of the housing 22 to one of a shower head 104 or an outside water spigot/pipe 106, typically used for a garden hose. In FIG. 9, the adapter assembly 102 can include a quick release connector 108. In FIGS. 6 and 7, the adapter assembly 102 includes a showerhead diverter 103, to select whether the flow of water goes through the showerhead 104 or through the hose 100 leading to the housing 22. In FIGS. 8 and 9, the adapter assembly 102 includes a diverter valve 105. Many alternatives are possible.

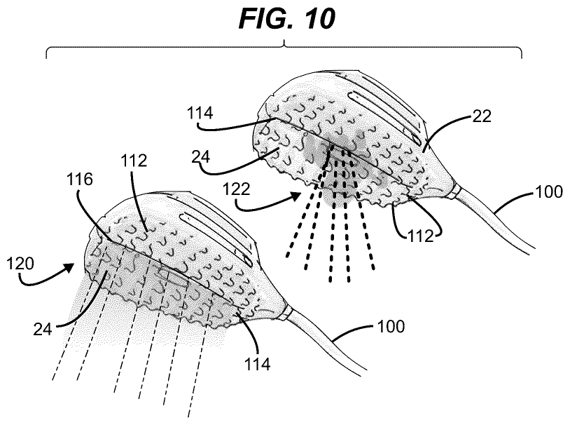

The animal engaging section 24 can include bristles 112, such as silicone bristles, for lathering along a face 114. In FIG. 10, the face 114 is shown with apertures 116 between the bristles 112 in communication with the interior volume 96 of the housing 22 and the solutions in the cartridge 50. The apertures 116 can form a plurality (e.g., at least two) selected flow patterns 120, 122. For example, there can be a different flow pattern for soaking, soaping, and rinsing.

The tool 30 further includes a pressure adjusting member 150 for selectively adjusting the water pressure. In the embodiment shown, the pressure adjusting member is a dial 152 located at the second end 36 of the housing 22. The dial 152 is preferably located adjacent to the fluid inlet opening/receiver 98. The dial 152 may be angled downwardly and away from a remaining portion of the housing 22 to provide comfort grip when the housing 22 is flipped over with the bottom 40 facing upward.

Many different ways are possible for making the housing 22. For example, the housing 22 can be constructed from a rigid core and a silicone outer covering. The silicone covering may be overmolded onto the core, in one example.

The above can be used in a method of bathing an animal. The method includes connecting housing 22 to a water source to permit water to flow from the source into interior volume 96 of the housing 22.

The method can include placing bristles 112 of the animal engaging section 24 secured to the housing 22 and in communication with the interior volume 96 of the housing 22 against the animal.

The method can include dispensing solutions from cartridge 50 removably held by the housing 22. The cartridge 50 is held within the housing 22 such that the solutions are in communication with the animal engaging section 24.

The step of dispensing solutions can include engaging one or more control buttons 94 on the housing 22 to control solution dispensed from the cartridge 50.

The method may further include using ejector mechanism 78 to selectively eject the cartridge 50 from the housing 22.

In preferred methods, the steps of placing bristles 112 and dispensing solutions are done with a single hand 92 holding the housing 22.

In preferred methods, there is a step of grasping the housing 22 through open ring 82 with human hand 92 so that the hand 92 is in the ring 82 between handle 88 and remaining part 90 of the housing 22.

### Aspects

Aspect 1. A handheld wash tool for bathing an animal; the tool comprising: (a) a housing with an interior volume; the housing having a receiver adapted to receive a water source to permit water to flow from the source into the interior volume; (b) an animal engaging section secured to the housing and in communication with the interior volume of the housing; the animal engaging section having bristles; and (c) a cartridge removably held by the housing; the cartridge holding one or more solutions for applying to the animal; the cartridge being held within the housing such that the one or more solutions is in communication with the animal engaging section.

Aspect 2. The tool of aspect 1 wherein the cartridge is constructed and arranged to hold at least two solutions in separate compartments.

Aspect 3. The tool of any one of aspects 1 and 2 wherein the housing includes first and second opposite ends, a top, and a bottom; the animal engaging section being along the bottom of the housing; a first axis generally orthogonal to a plane containing the animal engaging section and passing through the housing top and bottom; and a second axis passing through the first end and second end.

Aspect 4. The tool of aspect 3 wherein the housing has a first ring with a first ring central axis; the first ring central axis being contained in a plane orthogonal to the first axis; the first open ring being sized to receive the cartridge.

Aspect 5. The tool of any one of aspects 3 and 4 wherein the housing has a second open ring with a second ring central axis; the second ring central axis being contained in a plane orthogonal to the first axis; the second open ring being sized to receive a palm of a hand, such that fingers may extend over a side of the housing while a thumb may rest on the first end of the housing.

Aspect 6. The tool of any one of aspects 3-5 wherein the first end of the housing includes one or more control buttons constructed and arranged to engage the cartridge to control solution dispensed from the cartridge.

Aspect 7. The tool of any one of aspects 3-6 wherein the second end of the housing defines the receiver.

Aspect 8. The tool of any one of aspects 1-7 wherein the animal engaging section includes apertures having at least two selected flow patterns.

Aspect 9. The tool of any one of aspects 1-8 further including an adapter to selectively connect the housing to one of a shower head or a hose.

Aspect 10. The tool of any one of aspects 1-9 wherein the housing includes an ejection mechanism to selectively eject the cartridge from the housing.

The tool of any one of aspects 1-9, alone or in any combination, and/or in combination with any component or subcomponent shown in the drawings.

Aspect 11. A method of bathing an animal; the method comprising: (a) connecting a housing to a water source to permit water to flow from the source into an interior volume of the housing; (b) placing bristles of an animal engaging section secured to the housing and in communication with the interior volume of the housing against the animal; and (c) dispensing solutions from a cartridge removably held by the housing; the cartridge being held within the housing such that the solutions are in communication with the animal engaging section.

Aspect 12. The method of aspect 11 wherein the step of dispensing solutions includes using the cartridge to hold at least two solutions in separate compartments.

Aspect 13. The method of any one of aspects 11 and 12 wherein the step of dispensing solutions includes engaging one or more control buttons on the housing to control solution dispensed from the cartridge.

Aspect 14. The method of any one of aspects 11-13 further including using an ejection mechanism to selectively eject the cartridge from the housing.

Aspect 15. The method of any one of aspects 11-14 wherein the steps of placing bristles and dispensing solutions are done with a single hand holding the housing.

Aspect 16. The method of any one of aspects 11-15 including a step of grasping the housing through an open ring with a human hand so that the hand is in the ring between a handle and a remaining part of the housing.

Aspect 17. The method of any one of aspects 11-16 using the tool of any one of aspects 1-10, and/or in combination with any component or subcomponent of anything in the drawings.

The above describes example principles. Many embodiments can be made using these principles.

What is claimed is:

1. A handheld wash tool for bathing an animal; the tool comprising:
(a) a housing with an interior volume; the housing having a receiver adapted to receive a water source to permit water to flow from the source into the interior volume;
(b) an animal engaging section secured to the housing and in communication with the interior volume of the housing; the animal engaging section having bristles; and
(c) a cartridge removably held by the housing; the cartridge holding one or more solutions for applying to the animal; the cartridge being held within the housing such that the one or more solutions is in communication with the animal engaging section.

2. The tool of claim 1 wherein the cartridge is constructed and arranged to hold at least two solutions in separate compartments.

3. The tool of claim 1 wherein the housing includes first and second opposite ends, a top, and a bottom; the animal engaging section being along the bottom of the housing; a first axis generally orthogonal to a plane containing the animal engaging section and passing through the housing top and bottom; and a second axis passing through the first end and second end.

4. The tool of claim 3 wherein the housing has a first ring with a first ring central axis; the first ring central axis being contained in a plane orthogonal to the first axis; the first open ring being sized to receive the cartridge.

5. The tool of claim 3 wherein the housing has a second open ring with a second ring central axis; the second ring central axis being contained in a plane orthogonal to the first axis; the second open ring being sized to receive a palm of a hand, such that fingers may extend over a side of the housing while a thumb may rest on the first end of the housing.

6. The tool of claim 3 wherein the first end of the housing includes one or more control buttons constructed and arranged to engage the cartridge to control solution dispensed from the cartridge.

7. The tool of claim 3 wherein the second end of the housing defines the receiver.

8. The tool of claim 1 wherein the animal engaging section includes apertures having at least two selected flow patterns.

9. The tool of claim 1 further including an adapter to selectively connect the housing to one of a shower head or a hose.

10. The tool of claim 1 wherein the housing includes an ejection mechanism to selectively eject the cartridge from the housing.

11. A method of bathing an animal; the method comprising:
(a) connecting a housing to a water source to permit water to flow from the source into an interior volume of the housing;
(b) placing bristles of an animal engaging section secured to the housing and in communication with the interior volume of the housing against the animal; and
(c) dispensing solutions from a cartridge removably held by the housing; the cartridge being held within the housing such that the solutions are in communication with the animal engaging section.

12. The method of claim 11 wherein the step of dispensing solutions includes using the cartridge to hold at least two solutions in separate compartments.

13. The method of claim 11 wherein the step of dispensing solutions includes engaging one or more control buttons on the housing to control solution dispensed from the cartridge.

14. The method of claim 11 further including using an ejection mechanism to selectively eject the cartridge from the housing.

15. The method of claim 11 wherein the steps of placing bristles and dispensing solutions are done with a single hand holding the housing.

16. The method of claim 11 including a step of grasping the housing through an open ring with a human hand so that the hand is in the ring between a handle and a remaining part of the housing.

17. (canceled)
